(19) United States
(12) Patent Application Publication
(10) Pub. No.: US 2026/0195293 A1
(43) Pub. Date: Jul. 9, 2026

(54) MULTIPROCESSOR APPARATUS PERFORMING COLLECTIVE OPERATION, PROCESSING APPARATUS AND OPERATING METHOD OF PROCESSING APPARATUS

(71) Applicant: SAMSUNG ELECTRONICS CO., LTD., Suwon-si (KR)

(72) Inventor: Seok KANG, Suwon-si (KR)

(73) Assignee: SAMSUNG ELECTRONICS CO., LTD., Suwon-si (KR)

(21) Appl. No.: 19/338,062

(22) Filed: Sep. 24, 2025

(30) Foreign Application Priority Data
Jan. 6, 2025 (KR) 10-2025-0001483

(51) Int. Cl. G06F 15/78

(52) U.S. Cl. CPC G06F 15/7825; G06F 15/781

(57) ABSTRACT

Provided is a multiprocessor apparatus including: a plurality of processing circuits each including at least one processor and memory storing one or more instructions, wherein, for each respective processing circuit of the plurality of processing circuits, the at least one processor is configured to individually or collectively execute the one or more instructions and cause the respective processing circuit to: transmit data stored in the memory to another processing circuit of the plurality of processing circuits, receive, from the other processing circuit, data stored in the memory of the other processing circuit, provide the data received from the other processing circuit to the at least one processor, and perform an operation based on the data stored in the memory and the data received from the other processing circuit.

### CROSS-REFERENCE TO RELATED APPLICATION

This application claims priority to Korean Patent Application No. 10-2025-0001483, filed on Jan. 6, 2025, in the Korean Intellectual Property Office, the entire disclosure of which is incorporated herein by reference for all purposes.

### BACKGROUND

### 1. Field

The disclosure relates to a multiprocessor apparatus performing a collective operation, a processing apparatus, and an operating method of the processing apparatus.

### 2. Description of the Related Art

Distributed processing using a multiprocessor includes a technology that processes a task in parallel by utilizing multiple processors or computing nodes. This distributed processing technology may focus on improving work speed and efficient use of system resources. Distributed processing technology is widely used in modern computer systems to maximize performance and scalability. For example, distributed processing technology is used in the fields of supercomputers, cluster computing, big data processing, cloud computing, and artificial intelligence models.

### SUMMARY

According to an aspect of the disclosure, a multiprocessor apparatus includes: a plurality of processing circuits each including at least one processor and memory storing one or more instructions, wherein, for each respective processing circuit of the plurality of processing circuits, the at least one processor is configured to individually or collectively execute the one or more instructions and cause the respective processing circuit to: transmit data stored in the memory to another processing circuit of the plurality of processing circuits, receive, from the other processing circuit, data stored in the memory of the other processing circuit, provide the data received from the other processing circuit to the at least one processor, and perform an operation based on the data stored in the memory and the data received from the other processing circuit.

Each respective processing circuit of the plurality of processing circuits may further include: a data communication circuit; and a memory interface circuit, and wherein, for each of the respective processing circuits of the plurality of processing circuits: the memory interface circuit is configured to transmit the data stored in the memory to the at least one processor and to the data communication circuit, and the data communication circuit is configured to send the data stored in the memory to the data communication circuit of the other processing circuit, and to receive the data from the other processing circuit.

For each of the respective processing circuits of the plurality of processing circuits the data communication circuit may be further configured to: transmit the data received by the at least one processor via the memory interface circuit to the other processing circuit, and provide the data received from the other processing circuit to the at least one processor.

For each of the respective processing circuits of the plurality of processing circuits, the data received from the other processing circuit may not stored in the memory and may be directly transmitted from the data communication circuit to the at least one processor.

For each of the respective processing circuits of the plurality of processing circuits, the data communication circuit may include a network on chip.

For each of the respective processing circuits of the plurality of processing circuits, the at least one processor may be configured to individually or collectively execute the one or more instructions and further cause the respective processing circuit to: store, in a buffer, the data received by the at least one processor from the memory interface circuit and the data received from the other processing circuit via the data communication circuit, and perform the operation in response to the data from each of the plurality of processing circuits being collected.

For each of the respective processing circuits of the plurality of processing circuits, the data received from the other processing circuit may be transferred from the data communication circuit to the at least one processor.

The plurality of processing circuits may include: first processing circuits included in a first group; and second processing circuits included in a second group. The first processing circuits may be configured to transfer data to, or receive data from, only processing circuits included in the first processing circuits, and the second processing circuits may be configured to transfer data to, or receive data from, only processing circuits included in the second processing circuits.

The plurality of processing circuits may be configured to perform an all-gather operation before performing the operation based on the data stored in the memory and the data received from the other processing circuit.

According to an aspect of the disclosure, a processing apparatus includes: memory storing data and one or more instructions; at least one processor configured to execute the one or more instructions; a memory interface circuit configured to transmit the data to the at least one processor; and a data communication circuit configured to communicate with another processing apparatus, wherein the data communication circuit is configured to: receive the data from the memory interface circuit, transmit the received data to the other processing apparatus, receive other data from the other processing apparatus, and transmit the received other data to the at least one processor, and wherein the one or more instructions, when executed by the at least one processor, cause the at least one processor to perform an operation based on the data received from the memory interface circuit and the other data received from the data communication circuit.

The one or more instructions, when executed by the at least one processor, may further cause the at least one processor to: store, in a buffer, the data received from the memory interface circuit and the other data received from the data communication circuit, and perform the operation in response to receiving the data received from the memory interface circuit and the other data.

The other data may not be stored in the memory and may be directly transmitted from the data communication circuit to the at least one processor.

The processing apparatus and the other processing apparatus may each have the data and the other data.

The data communication circuit may be further configured to: transmit the data to a plurality of other processing apparatuses, wherein the plurality of other processing apparatuses includes the other processing apparatus, and wherein the plurality of other processing apparatuses form a data sharing group with the processing apparatus, and receive other data from each of the plurality of other processing apparatuses in the data sharing group.

The data stored in the memory may be previously generated by the operation of the at least one processor.

According to an aspect of the disclosure, an operating method performed by a processing apparatus includes: generating data by the processing apparatus performing an operation; storing the generated data in a memory of the processing apparatus; performing data sharing processing for a collective operation with another processing apparatus; and performing an operation based on the data stored in the memory and other data received from the other processing apparatus via the data sharing processing, wherein the performing the data sharing processing includes: transmitting the data stored in the memory to the other processing apparatus; receiving the other data from the other processing apparatus; and providing the received other data to at least one processor of the processing apparatus.

The performing the operation may include: receiving, by the at least one processor, the data stored in the memory through a memory interface circuit of the processing apparatus; storing in a buffer of the processing apparatus, by the at least one processor, the other data received from a data communication circuit of the other processing apparatus; and performing, by the at least one processor, the operation based on the data stored in the memory and the other data received from the other processing apparatus.

The other data may not be stored in the memory and may be directly transmitted from the data communication circuit of the processing apparatus to the at least one processor.

The performing the data sharing processing may further include: transmitting the data to a plurality of other processing apparatuses, wherein the plurality of other processing apparatuses includes the other processing apparatus, and wherein the plurality of other processing apparatuses form a data sharing group with the processing apparatus; and receiving other data from each of the plurality of other processing apparatuses in the data sharing group.

The data sharing processing may include an all-gather operation.

According to an aspect of the disclosure, a multiprocessor apparatus includes: a plurality of processing circuits each including at least one processor and memory storing one or more instructions, wherein, for each respective processing circuit of the plurality of processing circuits, the at least one processor of the respective processing circuit is configured to individually or collectively execute the one or more instructions stored in the memory of the respective processing circuit and cause the respective processing circuit to: a) transmit data stored in the memory to another processing circuit of the plurality of processing circuits, wherein the data is associated with a collective operation, b) receive, from the other processing circuit, data stored in the memory of the other processing circuit, c) provide the data received from the other processing circuit to the at least one processor, d) repeat operations a)-c) until each processing circuit of the plurality of processing circuits obtains a copy of the data associated with the collective operation stored in the memory each of the plurality of processing circuits, and perform the collective operation based on the data stored in the memory and the data received from the other processing circuits of the plurality of processing circuits.

Additional aspects of one or more embodiments will be set forth in part in the description which follows and, in part, will be apparent from the description, or may be learned by practice of the disclosure.

### BRIEF DESCRIPTION OF THE DRAWINGS

The above and other aspects and features of certain embodiments of the present disclosure will be more apparent from the following description taken in conjunction with the accompanying drawings, in which:

FIG. 1 is a diagram illustrating a multiprocessor apparatus performing a collective operation according to one or more embodiments;

FIG. 2 is a diagram illustrating data sharing processing according to one or more embodiments;

FIG. 3 is a diagram illustrating data sharing processing performed by a multiprocessor apparatus according to one or more embodiments;

FIGS. 4 and 5 are flowcharts illustrating operations of an operating method of a processing apparatus according to one or more embodiments;

FIGS. 6A, 6B, and 6C are diagrams illustrating data sharing processing based on a plurality of data sharing groups according to one or more embodiments; and

FIG. 7 is a block diagram illustrating a configuration of a processing apparatus according to one or more embodiments.

### DETAILED DESCRIPTION

The following detailed structural or functional description is provided as an example only and various alterations and modifications may be made to the embodiments described herein. Accordingly, the embodiments described herein are not intended to limit the disclosure and should be understood to include all changes, equivalents, and replacements within the idea and the technical scope of the disclosure.

Although terms of “first” or “second” are used to explain various components, the components are not limited to the terms. These terms should be used only to distinguish one component from another component. For example, a first component may be referred to as a second component, and similarly, the second component may also be referred to as the first component.

It will be understood that when a component is referred to as being “connected to” or “coupled” to another component, the component may be directly connected or coupled to the other component or intervening components may be present.

As used herein, the singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

As used in connection with one or more embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. The module may be implemented in a form of an application-specific integrated circuit (ASIC).

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

As used herein, the expressions “at least one of a, b or c” and “at least one of a, b and c” indicate “only a,” “only b,” “only c,” “both a and b,” “both a and c,” “both b and c,” and “all of a, b, and c.”

With regard to any method or process described herein, an identification code may be used for the convenience of the description but is not intended to illustrate the order of each step or operation. Each step or operation may be implemented in an order different from the illustrated order unless the context clearly indicates otherwise. One or more steps or operations may be omitted unless the context of the disclosure clearly indicates otherwise.

The various actions, acts, blocks, steps, or the like in the flow diagrams may be performed in the order presented, in a different order, or simultaneously. Further, in one or more embodiments, some of the actions, acts, blocks, steps, or the like may be omitted, added, modified, skipped, or the like without departing from the scope of the disclosure.

Hereinafter, embodiments will be described in detail with reference to the accompanying drawings. When describing the embodiments with reference to the accompanying drawings, like reference numerals refer to like elements and any repeated description related thereto will be omitted.

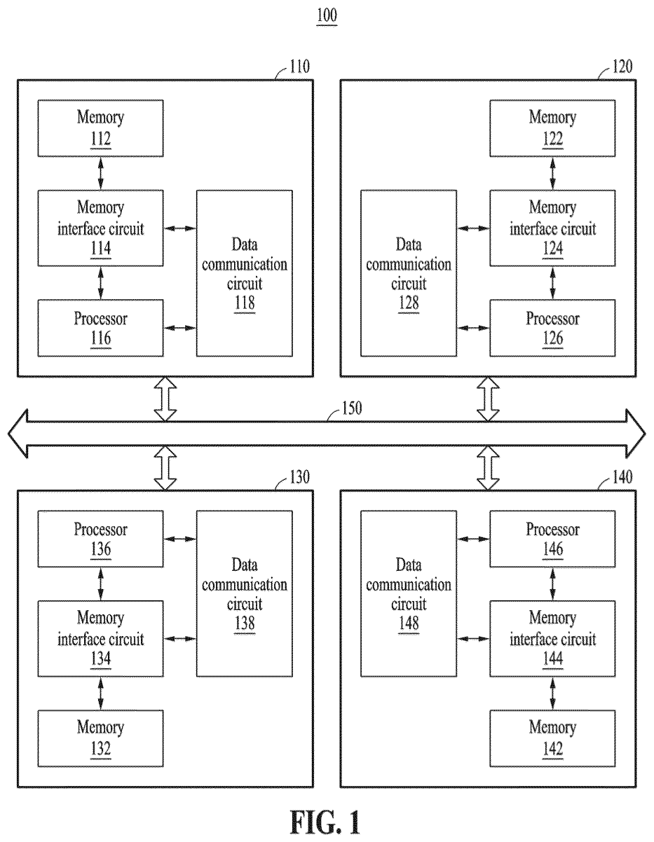

FIG. 1 is a diagram illustrating a multiprocessor apparatus performing a collective operation according to one or more embodiments.

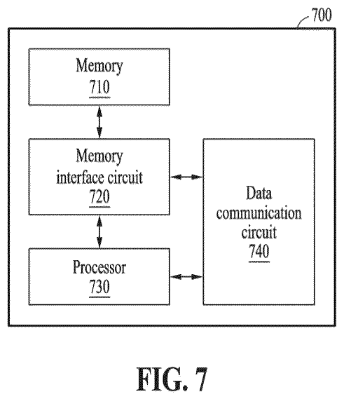

Referring to FIG. 1, a multiprocessor apparatus 100 may be an apparatus that performs distributed processing and/or parallel processing using a plurality of processing circuits 110, 120, 130, and 140 capable of performing operations. The processing circuits 110, 120, 130, and 140 may perform operations on a given set of data simultaneously and/or in parallel, and may each include processors 116, 126, 136, and 146. Although FIG. 1 illustrates that four processing circuits 110, 120, 130, and 140 are included in the multiprocessor apparatus 100, this is for ease of description, and the multiprocessor apparatus 100 may include two or more processing circuits, the number of which is not limited. Each of the processing circuits 110, 120, 130, and 140 may also be referred to as a processing apparatus or a computing node. Each of the processing circuits 110, 120, 130, and 140 may be replaced with a processing apparatus 700 described with reference to FIG. 7.

The processing circuits 110, 120, 130, and 140 may be used to accelerate large-scale data processing through parallel processing and/or distributed processing. Each of the processing circuits 110, 120, 130, and 140 may perform, for example, matrix operations including multiplication operations between vectors and matrices or multiplication operations between matrices, convolution operations including convolution operations on data, data parallelism in which data is divided into several pieces and each processing circuit independently performs the same operation, model parallelism in which operations of a neural network or transformer model are distributed and processed, and/or gradient operations in which gradients are calculated. Such operations may be performed by utilizing a parallel operation structure of the multiprocessor apparatus 100, and each of the processing circuits 110, 120, 130, and 140 may operate independently or cooperate with each other to quickly complete the entire processing operation. The multiprocessor apparatus 100 may be used in a server or an artificial intelligence (AI) accelerator. The multiprocessor apparatus 100 may be implemented in the form of a chip, for example, and may be applied to a data center or a multi-core system on chip (SoC).

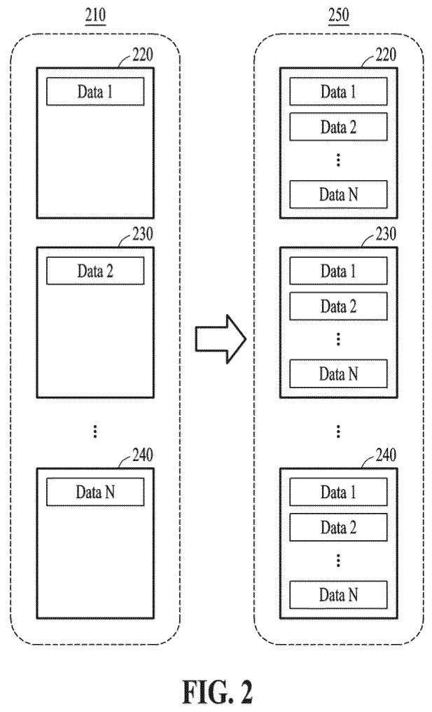

When data processing such as distributed processing and/or parallel processing is performed using the processing circuits 110, 120, 130, and 140, it may be beneficial that data is shared between the processing circuits 110, 120, 130, and 140 and that collective operations on the data are effectively processed. A collective operation may be an operation in which the processing circuits 110, 120, 130, and 140 cooperate to operate or communicate data in a parallel processing environment. The collective operation may be used for efficient distribution, sharing, or synchronization of data between the processing circuits 110, 120, 130, and 140. Among various collective processing operations, one of the most widely used in deep learning applications may be data sharing processing. Data sharing processing may be processing in which data held by each of the processing circuits 110, 120, 130, and 140 is shared among the processing circuits 110, 120, 130, and 140. Data sharing processing may be used when all processing circuits (or some processing circuits) are required to recognize data of other processing circuits. Data sharing processing may include, for example, an all-gather operation (or all-gather processing). The multiprocessor apparatus 100 may perform an all-gather operation when parallel processing using the processing circuits 110, 120, 130, and 140 is required, and the all-gather operation may be performed in real time depending on a data processing situation. Hereinafter, the data sharing processing including the all-gather operation is described in more detail with reference to FIG. 2.

FIG. 2 is a diagram illustrating data sharing processing according to one or more embodiments.

Referring to FIG. 2, a state 210 before data sharing processing is performed and a state 250 after data sharing processing is performed are illustrated. In one or more embodiments, a multiprocessor apparatus may include N processing circuits. In state 210, processing circuits 220, 230, and 240 may each have its own piece of data. For example, the first processing circuit 220 may have data 1, the second processing circuit 230 may have data 2, and the Nth processing circuit 240 may have data N. Data 1 may be generated by an operation of the first processing circuit 220, data 2 may be generated by an operation of the second processing circuit 230, and data N may be generated by an operation of the Nth processing circuit 240. Data 1, data 2, and data N may be, for example, variables or values derived through operations of each of the processing circuits 220, 230, and 240.

When it is determined that sharing the data held by each processing circuit 220, 230, and 240 is necessary to proceed with subsequent parallel operations, data sharing processing including an all-gather operation may be performed. When the data sharing processing is performed, each processing circuit 220, 230, and 240 may share the data pieces it has with other processing circuits. In state 250, after the data sharing processing is performed, all processing circuits 220, 230, and 240 may have all the data pieces of data 1, data 2, . . . , data N. The all-gather operation may allow all processing circuits 220, 230, and 240 to share a set of all the data pieces (e.g., data 1, data 2, . . . , data N).

Returning to FIG. 1, each of the processing circuits 110, 120, 130, and 140 included in the multiprocessor apparatus 100 may include a memory for storing data, a memory interface circuit for transmitting data to a processor and a data communication circuit, a data communication circuit for receiving other data from other processing circuits, and a processor for performing operations based on data stored in the memory and other data received from other processing circuits. The processing circuit 110 may include a memory 112, a memory interface circuit 114, a processor 116, and a data communication circuit 118, and the processing circuit 120 may include a memory 122, a memory interface circuit 124, a processor 126, and a data communication circuit 128. The processing circuit 130 may include a memory 132, a memory interface circuit 134, a processor 136, and a data communication circuit 138, and the processing circuit 140 may include a memory 142, a memory interface circuit 144, a processor 146, and a data communication circuit 148.

The memories 112, 122, 132, or 142 may include volatile memory and/or non-volatile memory. The memory interface circuits 114, 124, 134, or 144 may read previously stored data from the memory and transmit the data to the processor and the data communication circuit. The memory interface circuits 114, 124, 134, or 144 may be hardware and software components designed to allow components such as a processor and data communication circuit to interact with the memory. The memory interface circuits 114, 124, 134, or 144 may process and manage read/write requests to the memory. The data communication circuits 118, 128, 138, or 148 may perform data communication with other processing circuits. The data communication circuits 118, 128, 138, or 148 may include, for example, a network on chip (NoC) switch (or router). An NoC switch may forward data to various cores or computing nodes (e.g., processing circuits) and may manage the data to ensure that the data reaches its destination efficiently. The NoC switch may include components (e.g., an input port, an output port, a routing module to determine a path for data to reach its destination, a buffer to temporarily store data, a scheduler to determine a priority of data forwarding, and a network interface) necessary to route and forward data. The processors 116, 126, 136, or 146 may include a main processor (e.g., a central processing unit (CPU) or an application processor (AP)) or an auxiliary processor (e.g., a graphics processing unit (GPU), a neural processing unit (NPU), an image signal processor (ISP), a sensor hub processor, or a communication processor (CP)) that is operable independently of or in conjunction with the main processor. The processors 116, 126, 136, or 146 may also be referred to as a computation unit. The processors 116, 126, 136, or 146 may simultaneously receive data required for a collective operation from a memory interface circuit and a data communication circuit.

In one or more embodiments, the data communication circuit of each of the processing circuits 110, 120, 130, and 140 may transmit data stored in the memory to other processing circuits and receive other data from the other processing circuits via an NoC (or communication bus) 150. The NoC may be a network-based communication structure designed to efficiently process communication within a chip, and may be used to connect the processing circuits 110, 120, 130, and 140 in an SoC and to exchange data and signals. The processing circuits 110, 120, 130, and 140 may be fully connected to each other via the NoC.

When data sharing processing is performed, each of the processing circuits 110, 120, 130, and 140 may transmit data stored in the memories 112, 122, 132, or 142 to other processing circuits and receive other data stored in the other processing circuits from the other processing circuits. Each of the processing circuits 110, 120, 130, and 140 may transmit the received other data to the processors 116, 126, 136, or 146, and each processor 116, 126, 136, or 146 may perform an operation based on the data stored in the memories 112, 122, 132, or 142 and the other data received from the other processing circuits. Other data required for a collective operation may be transmitted directly to the processor from the data communication circuit without being stored in the memory.

The data communication circuit of each processing circuit 110, 120, 130, and 140 may transmit data received through a memory interface circuit to other processing circuits when data sharing processing is performed. The data communication circuit may receive other data from the other processing circuits and transmit the received other data to the processor. The other data received from the other processing circuits may be transmitted to the processor without being stored in the memory of each processing circuit 110, 120, 130, and 140. The amount of memory load and memory access may be reduced by loading the other data through a network such as an NoC rather than storing the other data in the memory. The processor of each processing circuit 110, 120, 130, and 140 may store the data received from the memory interface circuit and the other data received from the data communication circuit in a buffer, and perform an operation in response to the collection of all the data for the collective operation. Of all the data for the collective operation, the remaining data, excluding the data stored in the memory, may be transmitted to the processor from the data communication circuit. Each of the processing circuits 110, 120, 130, and 140 may load and use data corresponding to a result of the data sharing processing of the all-gather operation from the memory and the network. Through this process, the amount of data to be read from the memories 112, 122, 132, or 142, which are the local memory, in each of the processing circuits 110, 120, 130, and 140, may be reduced, thereby alleviating bottlenecks in which memory bandwidth limits performance. Operation results of each of the processing circuits 110, 120, 130, and 140 derived by performing the collective operation may be stored in the memory of each of the processing circuits 110, 120, 130, and 140 or transmitted to another device via a network.

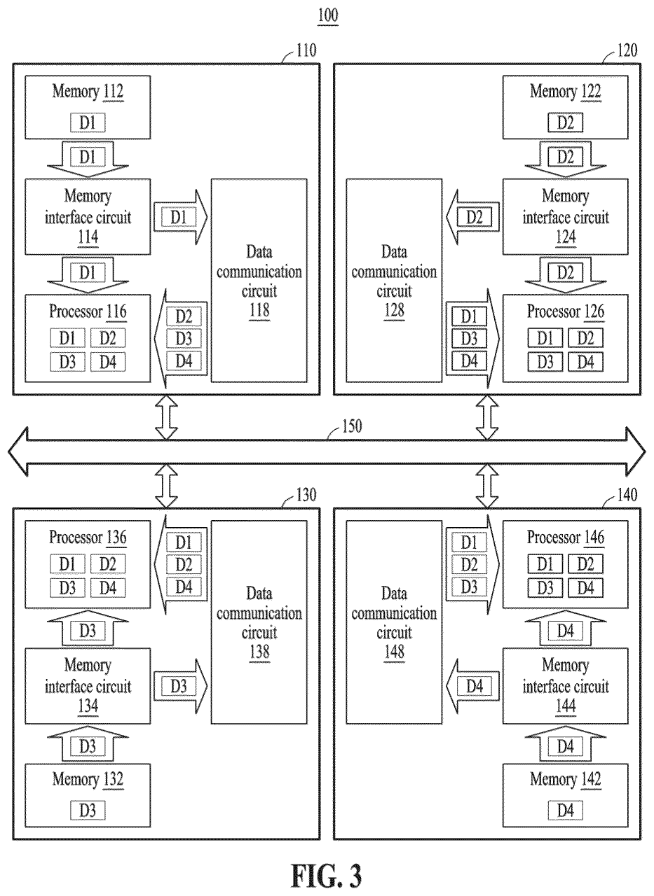

FIG. 3 is a diagram illustrating data sharing processing performed by a multiprocessor apparatus according to one or more embodiments.

Referring to FIG. 3, it is illustrated that four processing circuits 110, 120, 130, and 140 perform data sharing processing for collective operations on four pieces of data D1, D2, D3, and D4. Before the data sharing processing is performed, data D1 may be stored in the memory 112 of the processing circuit 110, data D2 may be stored in the memory 122 of the processing circuit 120, data D3 may be stored in the memory 132 of the processing circuit 130, and data D4 may be stored in the memory 142 of the processing circuit 140. The processing circuits 110, 120, 130, and 140 may each be driven individually.

In data sharing processing such as an all-gather operation, the processing circuits 110, 120, 130, and 140 may read data from their respective memories 112, 122, 132, and 142 and share the data through their respective data communication circuits 118, 128, 138, and 148 so that other processing circuits may also use the data. The data may be shared via the NoC (or communications bus) 150. The processing circuit 110 may read only data D1 from the memory 112 and transmit the data D1 to the processor 116 via the memory interface circuit 114. The processing circuit 110 may transmit data D1 to the other processing circuits 120, 130, and 140 via the data communication circuit 118. The other processing circuits 120, 130, and 140 may receive data D1 through their respective data communication circuits 128, 138, and 148. The processing circuit 120 may read only data D2 from the memory 122 and transmit the data D2 to the processor 126 via the memory interface circuit 124. The processing circuit 120 may transmit data D2 to the other processing circuits 110, 130, and 140 via the data communication circuit 128. The other processing circuits 110, 130, and 140 may receive data D2 through their respective data communication circuits 118, 138, and 148. The processing circuit 130 may read only data D3 from the memory 132 and transmit the data D3 to the processor 136 via the memory interface circuit 134. The processing circuit 130 may transmit data D3 to the other processing circuits 110, 120, and 140 via the data communication circuit 138. The other processing circuits 110, 120, and 140 may receive data D3 through their respective data communication circuits 118, 128, and 148. The processing circuit 140 may read only data D4 from the memory 142 and transmit the data D4 to the processor 146 via the memory interface circuit 144. The processing circuit 140 may transmit data D4 to the other processing circuits 110, 120, and 130 via the data communication circuit 148. The other processing circuits 110, 120, and 130 may receive data D4 through their respective data communication circuits 118, 128, and 138. When the data sharing processing as described above is completed, the processors 116, 126, 136, and 146 of each of the processing circuits 110, 120, 130, and 140 may share the four pieces of data D1, D2, D3, and D4.

The processing circuits 110, 120, 130, and 140 of the multiprocessor apparatus 100 may reduce the amount of data to be read from memory and memory read access by transmitting data received from the other processing circuits to their respective processors 116, 126, 136, and 146 without storing the data in their respective memories 112, 122, 132, and 142. For example, when each of the processing circuits 110, 120, 130, and 140 directly transmits the data received from the other processing circuits to the processors 116, 126, 136, and 146 without storing the data in memory, the amount of data to be read from the memory may be reduced to ¼ compared to when all four pieces of data D1, D2, D3, and D4 are stored in the memories 112, 122, 132, and 142 and the four pieces of data D1, D2, D3, and D4 are loaded into each processor. When all four pieces of data D1, D2, D3, and D4 are stored in the memories 112, 122, 132, and 142 and the four pieces of data D1, D2, D3, and D4 are loaded into each processor, when the memory bandwidth is not large enough to load the four pieces of data D1, D2, D3, and D4, the memory bandwidth may limit performance. In contrast, the data sharing processing proposed in this embodiment may load the four pieces of data D1, D2, D3, and D4 required for the collective operations via the memory and a network without storing the data in the respective memories 112, 122, 132, and 142 of the processing circuits 110, 120, 130, and 140, thereby reducing the amount of data to be read from the memories 112, 122, 132, and 144 and alleviating bottlenecks in which the memory bandwidth may limit performance.

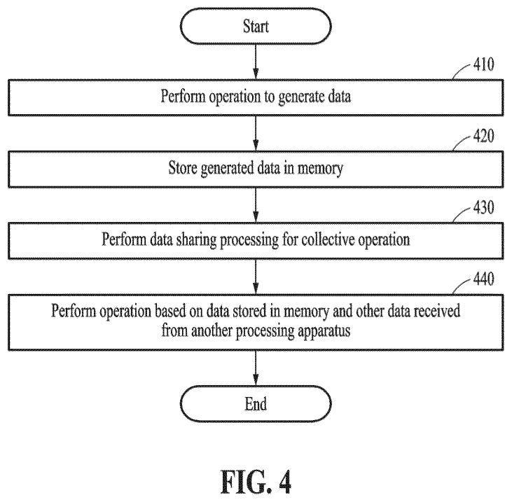

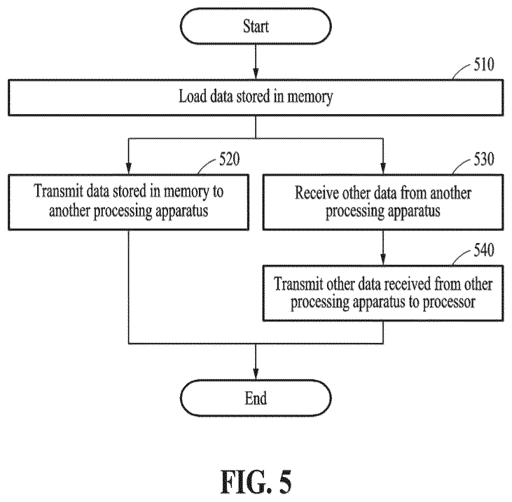

FIGS. 4 and 5 are flowcharts illustrating operations of an operating method of a processing apparatus according to one or more embodiments. An operating method of a processing apparatus may be performed by the processing apparatus (e.g., the processing apparatus 700 of FIG. 7) or the processing circuit (the processing circuit 110, the processing circuit 120, the processing circuit 130, or the processing circuit 140 of FIG. 1) described herein. Some of the operations of FIGS. 4 and 5 may be performed simultaneously or in parallel with another operation, and the order of the operations may be changed. In addition, some of the operations may be omitted or another operation may be additionally performed.

Referring to FIG. 4, in operation 410, the processing apparatus may perform an operation to generate data (e.g., variables). A processor (e.g., a processor 730 of FIG. 7, the processor 116, the processor 126, the processor 136, or the processor 146 of FIG. 1) of the processing apparatus may individually perform an operation to generate data. The operation may be, but is not limited to, a matrix operation, convolution operation, and/or gradient operation.

In operation 420, the processing apparatus may store the data generated through the operation in operation 410 in a memory (e.g., a memory 710 of FIG. 7, the memory 112, the memory 122, the memory 132, or the memory 142 of FIG. 1) of the processing apparatus.

In operation 430, the processing apparatus may perform data sharing processing for a collective operation with another processing apparatus. When the processing apparatus requires other data computed on another processing apparatus to perform additional operations, data sharing processing such as an all-gather operation may be performed. The data sharing processing may allow both the processing apparatus and the other processing apparatus to have the same data. An operation for performing the data sharing processing may include operations illustrated in FIG. 5. Hereinafter, the operation for performing the data sharing processing is described in more detail with reference to FIG. 5.

Referring to FIG. 5, in operation 510, the processing apparatus may load data stored in the memory. The processing apparatus may load data generated through a previous operation via a memory interface circuit (e.g., a memory interface circuit 720 of FIG. 7, the memory interface circuit 114, the memory interface circuit 124, the memory interface circuit 134, or the memory interface circuit 144 of FIG. 1).

In operation 520, the processing apparatus may transmit the data stored in the memory to another processing apparatus. The processing apparatus may transmit the data to the other processing apparatus via a data communication circuit (e.g., a data communication circuit 740 of FIG. 7, the data communication circuit 118, the data communication circuit 128, the data communication circuit 138, or the data communication circuit 148 of FIG. 1).

In operation 530, the processing apparatus may receive other data from another processing apparatus. The processing apparatus may receive other data stored in the memory of the other processing apparatus via the data communication circuit.

In operation 540, the processing apparatus may transmit the received other data to the processor (e.g., the processor 730 of FIG. 7, the processor 116, the processor 126, the processor 136, or the processor 146 of FIG. 1) of the processing apparatus so that the processor may perform an operation based on the data stored in the memory and the other data received from the other processing apparatus.

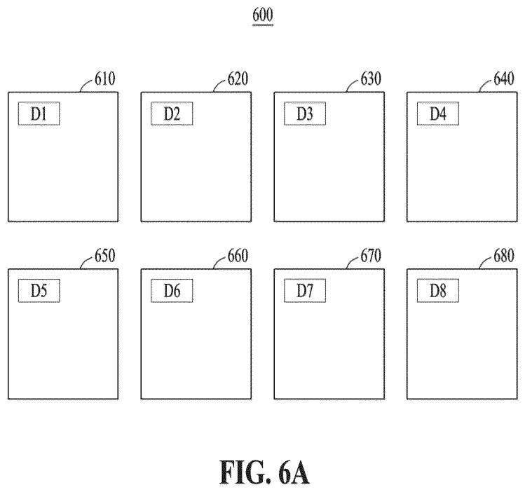

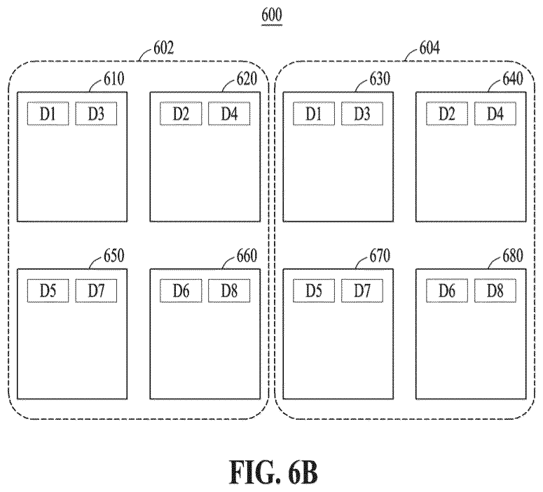

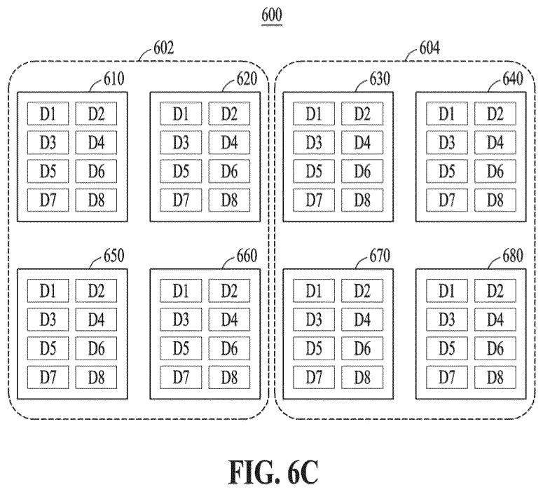

In one or more embodiments, a plurality of processing circuits of a multiprocessor apparatus (e.g., the multiprocessor apparatus 100 of FIG. 1) may be classified into a plurality of groups (or data sharing groups). For example, the processing circuits may include first processing circuits included in a first group and second processing circuits included in a second group. The first processing circuits may perform data sharing processing for collective operations between the first processing circuits, and the second processing circuits may perform data sharing processing for collective operations between the second processing circuits. In this case, an operation of performing the data sharing processing may include an operation of transmitting data to other processing apparatuses within a data sharing group to which the processing apparatus belongs among a plurality of other processing apparatuses, and an operation of receiving data held by each of the other processing apparatuses within the data sharing group from each of the other processing apparatuses within the data sharing group to which the processing apparatus belongs. An embodiment in which data sharing processing is performed based on a plurality of groups (data sharing groups) is described in more detail below with reference to FIG. 6.

Returning to FIG. 4, in operation 440, the processing apparatus may perform an operation based on the data stored in the memory and other data received from another processing apparatus through the data sharing processing. The processor of the processing apparatus may receive the data stored in the memory from the memory interface circuit of the processing apparatus and store the other data received from the data communication circuit of the processing apparatus in a buffer. The processor may perform an operation based on the data stored in the memory and the other data received from the other processing apparatus in response to the collection of all the data for the collective operation. The processor may determine that all the data for the collective operation is collected, for example, when it is determined that a predetermined number of data is collected. The processor may perform the collective operation on all the collected data.

FIGS. 6A, 6B, and 6C are diagrams illustrating performing data sharing processing based on a plurality of data sharing groups according to one or more embodiments.

According to one or more embodiments, a plurality of processing apparatuses (or processing circuits) may be classified into a plurality of data sharing groups, and data sharing processing may be performed on a data sharing group basis. Data required for data sharing processing including an all-gather operation may be distributed and stored within a data sharing group of processing apparatuses that may secure sufficient network bandwidth. Each processing apparatus within each data sharing group may load and use data required for collective operations from its own memory and a network within the data sharing group. A data sharing group may be predefined based on a network bandwidth used for communication between the processing apparatuses. The data sharing group may be changed depending on time or network conditions.

When data sharing processing is performed between processing apparatuses, network bandwidth may become a bottleneck that limits the processing performance (e.g., processing speed, time required) of collective operations because data is loaded via a network such as an NoC as well as memory. To reduce the possibility that network bandwidth may limit performance, processing apparatuses capable of securing sufficient network bandwidth may be designated as a data sharing group, and data sharing processing may be performed between processing apparatuses within the designated data sharing group.

FIG. 6A illustrates a state before data sharing processing is performed. FIG. 6A illustrates that a plurality of processing apparatuses 610, 620, 630, 640, 650, 660, 670, and 680 included in a multiprocessor apparatus 600 each have different data. The processing apparatus 610 has data D1 in its memory, and the processing apparatus 620 has data D2 in its memory. The processing apparatus 630 has data D3 in its memory, and the processing apparatus 640 has data D4 in its memory. The processing apparatus 650 has data D5 in its memory, and the processing apparatus 660 has data D6 in its memory. The processing apparatus 670 has data D7 in its memory, and the processing apparatus 680 has data D8 in its memory.

FIG. 6B illustrates that the plurality of processing apparatuses 610, 620, 630, 640, 650, 660, 670, and 680 are classified into two data sharing groups 602 and 604. The data sharing group 602 may include the processing apparatuses 610, 620, 650, and 660, and the data sharing group 604 may include the processing apparatuses 630, 640, 670, and 680. Before the data sharing processing including an all-gather operation is performed, the processing apparatus 610 and the processing apparatus 630 may be required to store at least data D1 and data D3, and the processing apparatus 620 and the processing apparatus 640 may be required to store at least data D2 and data D4. The processing apparatus 650 and the processing apparatus 670 may be required to store at least data D5 and data D7, and the processing apparatus 660 and the processing apparatus 680 may be required to store at least data D6 and data D8.

In one or more embodiments, each of the processing apparatuses 610, 620, 630, 640, 650, 660, 670, and 680 may request necessary data from other processing apparatuses via the network and receive the necessary data from the other processing apparatuses. For example, the processing apparatus 610 may request data D3 that is additionally required in addition to data D1 that is previously stored in the memory from the processing apparatus 630 and receive the data D3 from the processing apparatus 630 via the network. The processing apparatus 610 may store the received data D3 in memory. The remaining processing apparatuses 620, 630, 640, 650, 660, 670, and 680 may also receive necessary data through a similar process and store the received data in memory.

When the processing apparatuses belonging to each data sharing group 602 and 604 complete data preparation as shown in FIG. 6B, the data sharing processing including the all-gather operation may be performed. The data sharing group 602 may perform data sharing processing for collective operations between the processing apparatuses 610, 620, 650, and 660 included in the data sharing group 602. The data sharing group 604 may perform data sharing processing for collective operations between the processing apparatuses 630, 640, 670, and 680 included in the data sharing group 604. Each processing apparatus included in each of the data sharing groups 602 and 604 may transmit data stored in its memory to other processing apparatuses within the data sharing group, and receive data held by each of the other processing apparatuses within the data sharing group. For example, the processing apparatus 610 may transmit data D1 and data D3 previously stored in the memory to the other processing apparatuses 620, 650, and 660 included in the data sharing group 602. The processing apparatus 610 may receive data D2 and data D4 from the processing apparatus 620, data D5 and data D7 from the processing apparatus 650, and data D6 and data D8 from the processing apparatus 660. The remaining processing apparatuses 620, 650, and 660 within the data sharing group 602 may also share data through a similar process. The other data received by each of the processing apparatuses 610, 620, 650, and 660 via the network may be transmitted to the processor of each processing apparatus without being stored in the memory. The processing apparatuses 630, 640, 670, and 680 included in the data sharing group 604 may also perform data sharing processing according to a process similar to the data sharing processing of the data sharing group 602 described above.

FIG. 6C illustrates a state after data sharing processing is completed in each of the data sharing groups 602 and 604. After data sharing processing, each of the processing apparatuses 610, 620, 630, 640, 650, 660, 670, and 680 may have all the same data D1, D2, D3, D4, D5, D6, D7, and D8 and may perform operations defined in the collective operations based on all the data.

FIG. 7 is a block diagram illustrating a configuration of a processing apparatus according to one or more embodiments.

Referring to FIG. 7, the processing apparatus 700 may include the memory 710, the memory interface circuit 720, the processor 730, and the data communication circuit 740. The processing apparatus 700 may correspond to the processing circuit (e.g., the processing circuit 110, the processing circuit 120, the processing circuit 130, and the processing circuit 140 of FIG. 1) described herein.

The memory 710 may store data. The memory 710 may include a volatile memory and/or a non-volatile memory.

The memory interface circuit 720 may transmit data to the processor 730 and/or the data communication circuit 740. The memory interface circuit 720 may read previously stored data from the memory 710 and transmit the data to the processor 730 and/or the data communication circuit 740. The memory interface circuit 720 may be a hardware and software component designed to allow components such as the processor 730 and the data communication circuit 740 to interact with the memory. The memory interface circuit 720 may process and manage read/write requests to the memory 710.

The data communication circuit 740 may communicate with other processing apparatuses. The data communication circuit 740 may include, for example, an NoC switch (or router) for data communication with other processing circuits.

The processor 730 may include a main processor (e.g., a CPU or an AP) or an auxiliary processor (e.g., a GPU, an NPU, an ISP, a sensor hub processor, or a CP) that is operable independently of or in conjunction with the main processor. The processor 730 may also be referred to as a computation unit. The processor 730 may simultaneously receive data required for collective operations from the memory interface circuit 720 and the data communication circuit 740.

In one or more embodiments, the processing apparatus 700 may perform data sharing processing with other processing apparatuses for collective operations. Through data sharing processing, each of the processing apparatus 700 and the other processing apparatuses may have data stored in the processing apparatus 700 and other data stored in the other processing apparatuses.

When the processing apparatus 700 performs data sharing processing for a collective operation, the data communication circuit 740 may receive data stored in the memory 710 from the memory interface circuit 720 and transmit the received data to another processing apparatus. The other processing apparatus may transmit other data that the other processing apparatus has to the processing apparatus 700, and the data communication circuit 740 may receive the other data from the other processing apparatus. The data communication circuit 740 may transmit the received other data to the processor 730. The processor 730 may receive the data stored in the memory 710 from the memory interface circuit 720 for a collective operation and perform an operation based on the other data received from the data communication circuit 740. The data stored in the memory 710 may have been previously generated by an operation of the processor 730 and stored in the memory 710.

In one or more embodiments, the processor 730 may store the data received from the memory interface circuit 720 and the other data of another processing apparatus received from the data communication circuit 740 in a buffer. The buffer may be located within the processor 730. When there are multiple other processing apparatuses performing a collective operation, the data communication circuit 740 may receive other data stored in each of the other processing apparatuses from each of the multiple other processing apparatuses, and transmit the received other data to the processor 730 whenever other data from the other processing apparatuses is received. The processor 730 may sequentially store the other data received in the buffer whenever the other data is transmitted from the data communication circuit 740. The other data transmitted from other processing apparatuses required for a collective operation may be transmitted directly from the data communication circuit 740 to the processor 730 without being stored in the memory 710. The processor 730 may perform an operation in response to all the data for the collective operation being collected. The processor 730 may perform an operation defined as a collective operation when all target data is collected.

In one or more embodiments, when there are a plurality of processing apparatuses performing collective operations, the plurality of processing apparatuses including the processing apparatus 700 may be classified into a plurality of data sharing groups. Each of the processing apparatuses included in the same data sharing group may share data with other processing apparatuses included in its own data sharing group and collect all the data for performing the collective operations from the other processing apparatuses. When data sharing processing is performed, the data communication circuit 740 may transmit data stored in the memory 710 to other processing apparatuses within the data sharing group to which the processing apparatus 700 belongs among a plurality of other processing apparatuses. The data communication circuit 740 may receive data held by each of the other processing apparatuses within the data sharing group from each of the other processing apparatuses within the data sharing group to which the processing apparatus 700 belongs. When all the data is collected from the data sharing group, the processor 730 may perform an operation defined in a collective operation based on all the collected data. The operation may be, but is not limited to, for example, a matrix operation, vector operation, convolution operation, or data parallel processing.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is singular; however, one of ordinary skill in the art will appreciate that a processing device may include a plurality of processing elements and a plurality of types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing apparatus to operate as desired. Software and/or data may be embodied permanently or temporarily in any type of machine, component, physical or virtual equipment, or computer storage medium or device capable of providing instructions or data to or being interpreted by the processing apparatus. The software also may be distributed over network-coupled computer systems so that the software is stored and executed in a distributed fashion. The software and data may be stored by one or more non-transitory computer-readable recording mediums. The software, including one or more instructions, may be executed individually or collectively by one or more processors.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

Although one or more embodiments have been described with reference to the accompanying drawings, one of ordinary skill in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents.

Therefore, other implementations, embodiments, and equivalents to the claims are also within the scope of the following claims.

What is claimed is:

1. A multiprocessor apparatus comprising:
a plurality of processing circuits each comprising at least one processor and memory storing one or more instructions,
wherein, for each respective processing circuit of the plurality of processing circuits, the at least one processor is configured to individually or collectively execute the one or more instructions and cause the respective processing circuit to:
a) transmit data stored in the memory to another processing circuit of the plurality of processing circuits,
b) receive, from the other processing circuit, data stored in the memory of the other processing circuit,
c) provide the data received from the other processing circuit to the at least one processor, and
perform an operation based on the data stored in the memory and the data received from the other processing circuit.

2. The multiprocessor apparatus of claim 1, wherein the data is associated with a collective operation,
wherein, for each of the respective processing circuits of the plurality of processing circuits, the at least one processor is configured to individually or collectively execute the one or more instructions and further cause the respective processing circuit to:
d) repeat operations a)-c) until each processing circuit of the plurality of processing circuits obtains a copy of the data associated with the collective operation stored in the memory each of the plurality of processing circuits, and
perform the collective operation based on the data stored in the memory and the data received from the other processing circuits.

3. The multiprocessor apparatus of claim 1, wherein each respective processing circuit of the plurality of processing circuits further comprises:
a data communication circuit; and
a memory interface circuit, and
wherein, for each of the respective processing circuits of the plurality of processing circuits:
the memory interface circuit is configured to transmit the data stored in the memory to the at least one processor and to the data communication circuit, and
the data communication circuit is configured to send the data stored in the memory to the data communication circuit of the other processing circuit, and to receive the data from the other processing circuit.

4. The multiprocessor apparatus of claim 3, wherein, for each of the respective processing circuits of the plurality of processing circuits, the data communication circuit is further configured to:
transmit the data received by the at least one processor via the memory interface circuit to the other processing circuit, and
provide the data received from the other processing circuit to the at least one processor.

5. The multiprocessor apparatus of claim 3, wherein, for each of the respective processing circuits of the plurality of processing circuits, the data received from the other processing circuit is not stored in the memory and is directly transmitted from the data communication circuit to the at least one processor.

6. The multiprocessor apparatus of claim 3, wherein, for each of the respective processing circuits of the plurality of processing circuits, the data communication circuit comprises a network on chip.

7. The multiprocessor apparatus of claim 3, wherein, for each of the respective processing circuits of the plurality of processing circuits, the at least one processor is configured to individually or collectively execute the one or more instructions and further cause the respective processing circuit to:
store, in a buffer, the data received by the at least one processor from the memory interface circuit and the data received from the other processing circuit via the data communication circuit, and
perform the operation in response to the data from each of the plurality of processing circuits being collected.

8. The multiprocessor apparatus of claim 3, wherein, for each of the respective processing circuits of the plurality of processing circuits, the data received from the other processing circuit is transferred from the data communication circuit to the at least one processor.

9. The multiprocessor apparatus of claim 1, wherein the plurality of processing circuits comprises:
first processing circuits included in a first group; and
second processing circuits included in a second group,
wherein, the first processing circuits are configured to transfer data to, or receive data from, only processing circuits included in the first processing circuits, and
wherein the second processing circuits are configured to transfer data to, or receive data from, only processing circuits included in the second processing circuits.

10. The multiprocessor apparatus of claim 1, wherein the plurality of processing circuits are configured to perform an all-gather operation before performing the operation based on the data stored in the memory and the data received from the other processing circuit.

11. A processing apparatus comprising:
memory storing data and one or more instructions;
at least one processor configured to execute the one or more instructions;
a memory interface circuit configured to transmit the data to the at least one processor; and
a data communication circuit configured to communicate with another processing apparatus,
wherein the data communication circuit is configured to:
receive the data from the memory interface circuit,
transmit the received data to the other processing apparatus,
receive other data from the other processing apparatus, and
transmit the received other data to the at least one processor, and
wherein the one or more instructions, when executed by the at least one processor, cause the at least one processor to perform an operation based on the data received from the memory interface circuit and the other data received from the data communication circuit.

12. The processing apparatus of claim 11, wherein the one or more instructions, when executed by the at least one processor, further cause the at least one processor to:
store, in a buffer, the data received from the memory interface circuit and the other data received from the data communication circuit, and
perform the operation in response to receiving the data received from the memory interface circuit and the other data.

13. The processing apparatus of claim 11, wherein the other data is not stored in the memory and is directly transmitted from the data communication circuit to the at least one processor.

14. The processing apparatus of claim 11, wherein the processing apparatus and the other processing apparatus each have the data and the other data.

15. The processing apparatus of claim 11, wherein the data communication circuit is further configured to:
transmit the data to a plurality of other processing apparatuses, wherein the plurality of other processing apparatuses includes the other processing apparatus, and wherein the plurality of other processing apparatuses form a data sharing group with the processing apparatus, and
receive other data from each of the plurality of other processing apparatuses in the data sharing group.

16. The processing apparatus of claim 11, wherein the data stored in the memory is previously generated by the operation of the at least one processor.

17. An operating method performed by a processing apparatus, the operating method comprising:
generating data by the processing apparatus performing an operation;
storing the generated data in a memory of the processing apparatus;
performing data sharing processing for a collective operation with another processing apparatus; and
performing an operation based on the data stored in the memory and other data received from the other processing apparatus via the data sharing processing,
wherein the performing the data sharing processing comprises:
transmitting the data stored in the memory to the other processing apparatus;
receiving the other data from the other processing apparatus; and
providing the received other data to at least one processor of the processing apparatus.

18. The operating method of claim 17, wherein the performing the operation comprises:
receiving, by the at least one processor, the data stored in the memory through a memory interface circuit of the processing apparatus;
storing in a buffer of the processing apparatus, by the at least one processor, the other data received from a data communication circuit of the other processing apparatus; and
performing, by the at least one processor, the operation based on the data stored in the memory and the other data received from the other processing apparatus.

19. The operating method of claim 18, wherein the other data is not stored in the memory and is directly transmitted from the data communication circuit of the processing apparatus to the at least one processor.

20. The operating method of claim 17, wherein the performing the data sharing processing further comprises:
transmitting the data to a plurality of other processing apparatuses, wherein the plurality of other processing apparatuses includes the other processing apparatus, and wherein the plurality of other processing apparatuses form a data sharing group with the processing apparatus; and
receiving other data from each of the plurality of other processing apparatuses in the data sharing group.
